(19) United States
(12) Patent Application Publication
(10) Pub. No.: US 2013/0133321 A1
(43) Pub. Date: May 30, 2013

(54) Drive System for a Vehicle

(71) Applicant: Bayerische Motoren Werke Aktiengesellschaft, Muenchen (DE)

(72) Inventors: Juergen Ringler, Bergkirchen (DE); Marco SEIFERT, Muenchen (DE); Wolfgang STROBL, Eichstaett (DE); Raymond FREYMANN, Thierry (LU); Andreas EDER, Muenchen (DE); Matthias LINDE, Haar (DE); Johannes LIEBL, Moosburg (DE)

(73) Assignee: Bayerische Motoren Werke Aktiengesellschaft, Muenchen (DE)

(21) Appl. No.: 13/747,221

(22) Filed: Jan. 22, 2013

(30) Foreign Application Priority Data
Jul. 23, 2010 (DE) 10 2010 038 314.7

(51) Int. Cl. F02B 65/00

(52) U.S. Cl. CPC F02B 65/00
USPC 60/597; 60/645

(57) ABSTRACT

The invention relates to a drive system for a vehicle, comprising an internal combustion that releases mechanical and thermal energy and a device for converting the thermal energy, wherein the device is designed to directly convert thermal energy into electrical energy and to transfer thermal energy to a working medium intended to act on an expansion apparatus.

### CROSS REFERENCE TO RELATED APPLICATIONS

This application is a continuation of PCT International Application No. PCT/EP2011/003268, filed Jul. 1, 2011, which claims priority under 35 U.S.C. §119 from German Patent Application No. 10 2010 038 314.7, filed Jul. 23, 2010, the entire disclosures of which are herein expressly incorporated by reference.

### BACKGROUND AND SUMMARY OF THE INVENTION

The present invention relates to a drive system for a vehicle, having an internal-combustion engine that releases mechanical and thermal energy and a device for converting the thermal energy, according to the preamble of Claim 1.

Known internal-combustion engines of vehicles have an efficiency which, despite multiple efforts and successive improvements, such as fully variable valve controls, combustion with excess air and the like, is in the range of maximally 40%, so that, conversely, a large part of the energy bound in the fuel is lost as waste heat to the environment. A large portion thereof is dissipated by way of the exhaust gas.

In order to take this circumstance into account, additional applications at the vehicle have been suggested, by means of which the residual energy present in the exhaust gas can be, for example, converted to electric energy, utilized to support the onboard power supply system of the vehicle or, converted to mechanical energy, and be coupled into the drive train for driving the vehicle.

One representative of the first-mentioned type of additional applications is the thermoelectric generator by means of which electric energy, for example, according to the Seebeck effect, can be obtained from the thermal energy present in the exhaust gas, which electric energy then no longer has to be produced generatively while consuming additional fuel.

Another additional application is described in the applicant's European Patent Application EP 1573194 B1, which discloses a thermal engine that generates mechanical work by way of a low-temperature circuit and a high-temperature circuit having a relaxation apparatus in each case connected on the output side, while utilizing the waste heat of the internal-combustion engine.

The overall efficiency of the drive system can already be increased by means of the two additional applications. The drive system nevertheless has the potential for further improvements which so far had not been opened up.

Based on the above, it is an object of the present invention to further develop the known drive system under the aspect of improving the overall efficiency.

For achieving this object, the invention has the characteristics set forth in the claims. Advantageous further developments are described in the additional claims.

The invention provides a drive system for a vehicle having an internal-combustion engine that releases mechanical and thermal energy and a device for converting the thermal energy, where the device is designed to directly convert thermal energy to electric energy and to transfer thermal energy to a working medium provided for acting upon an expansion apparatus.

This means in other words that the device provided for utilizing the thermal energy dissipated by the internal-combustion engine by way of the exhaust gas flow is constructed for directly converting the thermal energy to electric energy as well as for transferring thermal energy to a working medium by which, in turn, an expansion apparatus can be acted upon, so that, by means of the device, the thermal energy can be converted to electric energy as well as to mechanical energy.

As a result, the heat present in the exhaust gas flow of the internal-combustion engine can advantageously be utilized to generate electric current which, for example, assists the onboard power supply system of the vehicle, as well as to provide mechanical energy which, for example, for driving the vehicle, can be coupled into the drive train or can be used for driving a mechanically actuated component at the vehicle.

This causes the overall efficiency of the drive system to rise and, in addition, the advantage of an integration of functions is achieved because an evaporator necessary for evaporating the working medium is thereby simultaneously used as a cooler for a component, by means of which the thermal energy can be converted to electric energy.

The component for converting the thermal energy to electric energy may be a thermoelectric generator which has surfaces heated by means of the thermal energy, and surfaces cooled by means of the working medium, such that the working medium assumes a vaporous state because it is acted upon by heat.

As a result, the above-explained integration of functions is achieved, which makes it possible to represent components otherwise required to be independent discrete units, such as the evaporator and the cooler, jointly with only one component.

The working medium, which is in a vaporous state after passing through the device provided according to the invention, can then act upon an expansion apparatus, which may, for example, be a piston engine, by means of which a mechanically driven component at the vehicle is acted upon.

According to a further development of the invention, it is provided that the device has a condensation apparatus for the condensation of vaporous working medium after its passage through an expansion apparatus. The then-liquid working medium is fed, by means of a pumping device circulating the working medium, back into the device, which then again converts the working medium to the vaporous state by utilizing the residual energy present in the exhaust gas.

According to an embodiment, the device may be a heat exchanger, which has first surfaces heated by the exhaust gas of the internal-combustion engine, and second surfaces which are cooled by the working medium with thermoelectric pairs of legs arranged in-between. The device has at least one inlet for the working medium in the liquid state and one outlet for the working medium in the vaporous state and has, in each case, at least one inlet and outlet for the exhaust gas of the internal-combustion engine, which enters into the inlet, acts there upon the first surface with the hot side of the pairs of legs and is discharged again from the outlet at a lower temperature.

The working medium is used for cooling the second surface and absorbs thermal energy there from the hot exhaust gas in a largely isothermal manner and leaves the device as a vaporous phase in order to be fed to the above-mentioned expansion apparatus. In this manner, the heat present in the exhaust gas can be used in a combinatory fashion for generating electric and mechanical energy, whereby, on the whole, the overall efficiency of the drive system according to the invention can clearly be increased compared with known drive systems.

The invention creates a method for utilizing the thermal energy contained in the exhaust gas of an internal-combustion engine for the conversion to electric and mechanical energy by means of a thermoelectric generator and a Rankine steam process, in which case the heat absorption required for the evaporation of the working medium carried in the Rankine steam cycle process takes place largely isothermally, and the heat is withdrawn from the cold side of the thermoelectric generator heated by the exhaust gas.

In the case of the largely isothermal heat absorption by the working medium, the heat transferred from the exhaust gas of the internal-combustion engine to the working medium passes through a large temperature gradient. As a result of the temperature gradient during the heat transmission to the working medium, a loss of energy will occur.

By mounting the thermoelectric material on the hot and cold side of the heat transfer device, this loss of energy can be partially prevented in such a manner that the temperature gradient between the exhaust gas and the working medium—between the hot and cold side of the heat exchanger—caused by the largely isothermal heat absorption is utilized for driving the thermoelectric pairs of legs.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of an embodiment of a device provided in the drive system according to the invention for converting thermal energy to electric energy and for the admission of heat to a working medium;

FIG. 2 is a schematic representation of a drive system according to the present invention; and

FIG. 3 is a diagram with the transferred heat quantity on the x-axis for explaining the method of operation of the drive system according to the invention;

### DETAILED DESCRIPTION OF THE DRAWINGS

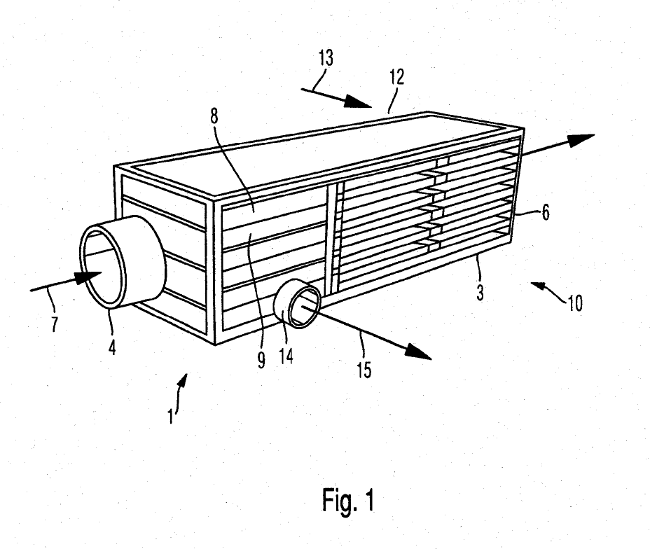

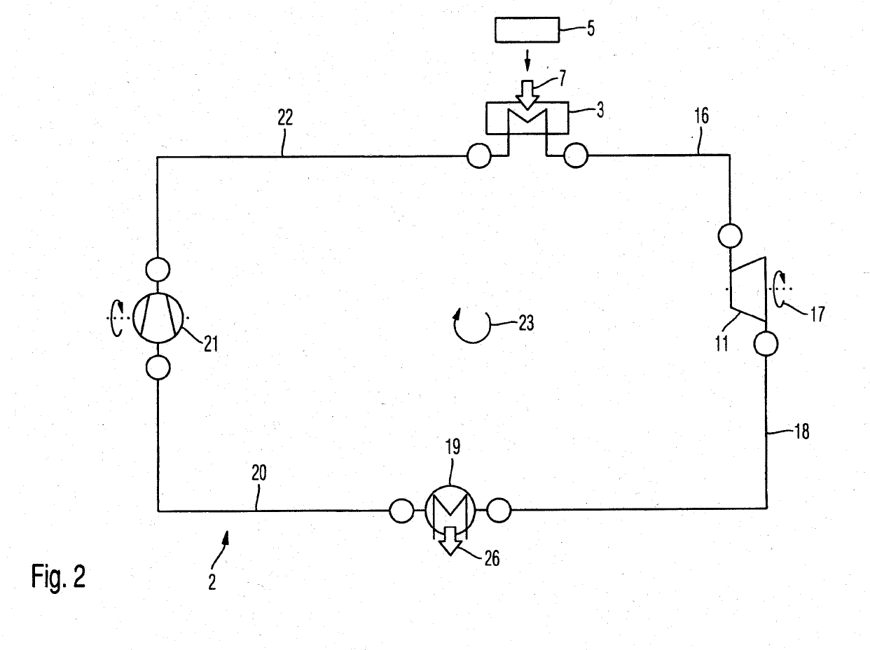

FIG. 1 of the drawing illustrates a device 1 which shows a component of the drive system 2 according to the invention, which drive system 2 is shown in a schematic representation in FIG. 2 of the drawing.

The device 1 illustrated in FIG. 1 comprises a heat exchanger 3 having an inlet 4 for the hot exhaust gas from the internal-combustion engine 5 illustrated in FIG. 2 of the drawing. On the face situated opposite the inlet 4, the heat exchanger 3 has an outlet 6 for the exhaust gas cooled in the heat exchanger 3, which outlet 6 is not shown in detail in the selected perspective representation.

The exhaust gas mass flow 7 originating from the internal-combustion engine 5 enters into the heat exchanger 3 by way of the inlet 4. The hot exhaust gas mass flow 7 heats the first surfaces 8 arranged in the heat exchanger 3 which correspond to the hot side of the thermoelectric generator 10 formed by thermoelectric pairs of legs. The thermoelectric pairs of legs, which are not shown in detail, are arranged between the respective hot first surfaces 8 and the respective cooled second surfaces 9.

In this case, the cooling of the respective second surfaces 9 takes place by way of a working medium of the expansion apparatus 11 illustrated in FIG. 2 of the drawing, for example, in the form of a piston machine.

At an inlet 12 not visible in detail because of the perspective representation, the working medium enters in the form of a liquid mass flow 12 into the heat exchanger 3, cools the respective second surfaces 9 there, absorbs the heat from the hot exhaust gas mass flow 7 in a largely isothermally occurring process of heat transfer, is evaporated and exits again as a vaporous mass flow at an outlet 14 from the heat exchanger 3.

FIG. 2 of the drawing illustrates the internal-combustion engine 5, starting from which the hot exhaust gas mass flow 7 enters into the heat exchanger 3. The vaporous working medium leaves the heat exchanger 3 and, by way of a schematically illustrated fluid line 16, is fed to the expansion apparatus 11, is relaxed there while losing pressure and is converted to mechanical energy symbolically illustrated by an arrow 17. This energy can be used, for example, for the drive of a mechanically actuated component of the vehicle not shown in detail or can be coupled into the drive train of the vehicle.

After leaving the expansion apparatus 11, the working medium is fed by way of a fluid line 18 to a condenser 19 and is converted there, while dissipating heat—as also indicated by the arrow 26—to the liquid phase. By way of a fluid line 20, a pumping device 21 can take in the liquid working medium and feed it by way of a further fluid line 22 back into the heat exchanger 3 and in this manner circulate the working medium, as illustrated by the arrow 23.

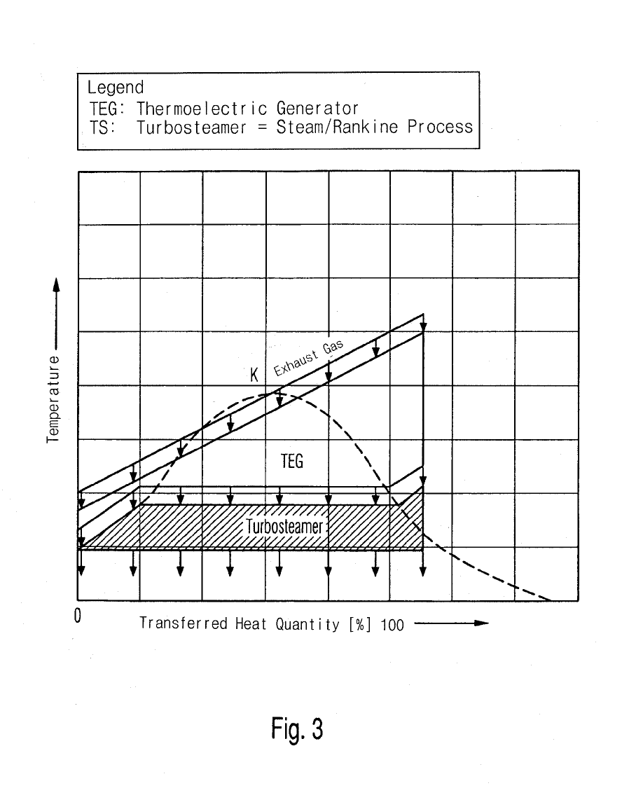

FIG. 3 of the drawing shows a diagram with the transferred heat quantity on the x-axis for explaining the method of operation of the drive system according to the invention.

The hot exhaust gas mass flow 7 enters into the heat exchanger 3 at a high temperature of, for example, 520° C. indicated by reference number 24, heats the hot side of the thermoelectric generator 10 there—the latter can, for example, be provided by a coating of surfaces of the heat exchanger 3 with thermoelectric material, which heat exchanger is necessary for the heat transfer to the working medium—, and emits heat on its path to the outlet 6 of the heat exchanger 3. Finally, the exhaust gas leaves the heat exchanger 3 at a temperature of approximately 200° indicated by reference number 25.

This heat is transferred largely isothermally to the working medium; the heat transfer takes place on the cold surface 9 of the heat exchanger 3 cooled by the working medium; and the working medium is evaporated here at overpressure.

The vaporous working medium drives the expansion apparatus 11 illustrated in FIG. 2 of the drawing and is cooled in the process. The drive system according to the invention permits the combinatory utilization of the residual energy present in the exhaust gas for providing electric energy within the scope of a thermoelectric process and for providing mechanical energy within the scope of a Rankine steam process.

The drive system according to the invention therefore makes it possible to utilize the residual energy present in the exhaust gas of the internal-combustion engine for providing electric energy and mechanical energy in a coupled process. The predominantly isothermal heat absorption when evaporating the working medium is simultaneously used as a very efficient cooling for the cold side of the thermoelectric generator, so that the waste heat available in the exhaust gas can be utilized almost completely for the conversion to useful energy and the amount of energy dissipated into the environment with the exhaust gas can clearly be reduced.

With respect to characteristics of the invention not explained above in detail, reference is explicitly made to the claims and the drawing.

### LIST OF REFERENCE NUMBERS

1 Device

2 Drive system

3 Heat exchanger

4 Inlet

5 Internal-combustion engine

6 Outlet

7 Exhaust gas mass flow

8 First surface

9 Second surface

10 Thermoelectric generator

11 Expansion apparatus

12 Inlet

13 Liquid mass flow working medium

14 Outlet

15 Vaporous mass flow working medium

16 Fluid line

17 Mechanical energy

18 Fluid line

19 Condenser

20 Fluid line

21 Pump

22 Fluid line

23 Arrow

24 Temperature at the exhaust gas inlet

25 Temperature at the exhaust gas outlet

26 Arrow

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A drive system for a vehicle, having an internal-combustion engine, that releases mechanical and thermal energy, and a device for converting the thermal energy,
wherein the device is configured to directly convert the thermal energy to electric energy and to transfer thermal energy to a working medium provided for acting upon an expansion apparatus.

2. The drive system according to claim 1,
wherein the device further comprises a thermoelectric generator with surfaces heated by the thermal energy and surfaces cooled by the working medium, such that the working medium assumes a vaporous state because it is acted upon by heat.

3. The drive system according to claim 1, wherein the expansion apparatus is configured to supply mechanical energy in response to being acted upon by the working medium when in a vaporous state.

4. The drive system according to claim 2, wherein the expansion apparatus is configured to supply mechanical energy in response to being acted upon by the working medium when in a vaporous state.

5. The drive system according to claim 1, further comprising a condensation device configured to condense the working medium when in a vaporous state after passage through the expansion apparatus.

6. The drive system according to claim 2, further comprising a condensation device configured to condense the working medium when in a vaporous state after passage through the expansion apparatus.

7. The drive system according to claim 3, further comprising a condensation device configured to condense the working medium when in a vaporous state after passage through the expansion apparatus.

8. The drive system according to claim 1, further comprising a pumping device configured to circulate the working medium.

9. The drive system according to claim 2, further comprising a pumping device configured to circulate the working medium.

10. The drive system according to claim 5, further comprising a pumping device configured to circulate the working medium.

11. The drive system according to claim 8, further comprising a pumping device configured to circulate the working medium.

12. The drive system according to claim 1, wherein the device has first surfaces heated by exhaust gas of the internal-combustion engine and second surfaces cooled by the working medium with thermoelectric pairs of legs arranged in-between, and wherein in the device further comprises at least one inlet and at least one outlet for the working medium, and at least one inlet and at least one outlet for exhaust gas.

13. The drive system according to claim 2, wherein the device has first surfaces heated by exhaust gas of the internal-combustion engine and second surfaces cooled by the working medium with thermoelectric pairs of legs arranged in-between, and wherein in the device further comprises at least one inlet and at least one outlet for the working medium, and at least one inlet and at least one outlet for exhaust gas.

14. The drive system according to claim 3, wherein the device has first surfaces heated by exhaust gas of the internal-combustion engine and second surfaces cooled by the working medium with thermoelectric pairs of legs arranged in-between, and wherein in the device further comprises at least one inlet and at least one outlet for the working medium, and at least one inlet and at least one outlet for exhaust gas.

15. The drive system according to claim 5, wherein the device has first surfaces heated by exhaust gas of the internal-combustion engine and second surfaces cooled by the working medium with thermoelectric pairs of legs arranged in-between, and wherein in the device further comprises at least one inlet and at least one outlet for the working medium, and at least one inlet and at least one outlet for exhaust gas.

16. The drive system according to claim 8, wherein the device has first surfaces heated by exhaust gas of the internal-combustion engine and second surfaces cooled by the working medium with thermoelectric pairs of legs arranged in-between, and wherein in the device further comprises at least one inlet and at least one outlet for the working medium, and at least one inlet and at least one outlet for exhaust gas.

17. A method for utilizing the thermal energy contained in exhaust gas of an internal-combustion engine for conversion to electric and mechanical energy using a thermoelectric generator and a Rankine steam process, wherein heat absorption required for evaporation of a working medium carried in the Rankine steam cycle process is largely isothermal, and wherein heat is withdrawn from a cold side of the thermoelectric generator heated by the exhaust gas.
